(19) United States
(12) Patent Application Publication
(10) Pub. No.: US 2017/0016544 A1
(43) Pub. Date: Jan. 19, 2017

(54) Valve Device for Controlling and Adjusting Fluid Passage

(71) Applicant: HAM-LET (ISRAEL-CANADA) LTD., Nazareth Illit (IL)

(72) Inventors: Yasuhiro CHIBA, Miyagi (JP); Toshikatsu MEGURO, Miyagi (JP)

(21) Appl. No.: 15/039,436

(22) PCT Filed: Nov. 27, 2014
(86) PCT No.: PCT/IL2014/051032

§ 371 Date: May 26, 2016

Related U.S. Application Data
(60) Provisional application No. 61/910,079, filed on Nov. 28, 2013.

(51) Int. Cl. F16K 7/16; F16K 31/122

(52) U.S. Cl. CPC F16K 7/16; F16K 31/1221

(57) ABSTRACT

A valve device for controlling passage of fluid in a flow system or part thereof comprising a diaphragm valve comprising a diaphragm and a diaphragm seat, the diaphragm valve is configured for controlling the passage of the fluid by being pressable towards and away from the seat; at least one laterally movable element having part thereof engaging the diaphragm for operating the diaphragm valve; an actuator for actuating the laterally movable element; an adjustment element configured for adjustment of lateral movement span of the laterally movable element by adjusting a relative position thereof; and at least one locking mechanism for locking the adjusted relative position of the adjustment element. The lateral movement span of the laterally moveable element determines the maximal distance between the diaphragm and the seat, which determines the throughput of the valve device.

### FIELD OF THE INVENTION

The present invention generally relates to devices, apparatuses, systems and methods for adjusting and controlling fluid (liquid or gas) flow and fluid passage in a flow system and in particular, the present invention relates to valve devices for adjusting and controlling fluid flow and passage having a diaphragm valve.

### BACKGROUND OF THE INVENTION

Many valve devices are available today for controlling passage of fluid through fluid guiding means such as through water or gas piping systems. Many valve devices use diaphragm valves for sealing and opening the valve as these diaphragms valves typically include a diaphragm and a seat upon which the diaphragm seals one or more openings of the system's pipeline. Some of the diaphragm valves are operated via a manual or an electronically controlled actuator which allows closing and opening the valve by moving the diaphragm to and from the diaphragm seat, respectively.

U.S. Pat. No. 4,732,363 discloses a diaphragm valve which uses a multiple annular metal diaphragm welded about its inner periphery to a valve operating stem.

The diaphragm is sealingly clamped about its outer periphery to the valve body and is also clamped about its inner periphery at a location spaced outwardly of the weld to prevent the weld from being subjected to flexure stresses during valve actuation. The actuating assembly is arranged to produce non-rotary, reciprocatory movement of the operating stem through a bonnet mounted rotary actuator. An improved stem tip seal arrangement is also disclosed.

U.S. Pat. No. 5,152,500 discloses an aseptic valve construction having a valve body having an inlet flow passage and at least one outlet flow passage, the valve body having a valve seat surrounding the inlet flow passage and an opening therein in alignment with the inlet passage and in communication with the inlet passage and with the outlet passage. The body also has a shoulder providing a shoulder seat surrounding the opening, an actuator sleeve adapted to be secured to said valve body, a shaft, means mounting the shaft in the sleeve to permit axial movement of the shaft in the sleeve, a diaphragm removably secured to the shaft, where the diaphragm engages with the valve seat, diaphragm actuator means engaging the shaft for causing axial movement of the shaft for moving the diaphragm between open and closed positions with respect to the valve seat whereby in a closed position the diaphragm interrupts the flow of a liquid from the inlet passage through the outlet passage and in an open position permits the flow of liquid from the inlet passage to the outlet passage; and means for preventing rotation of the diaphragm as the shaft is actuated to cause movement of the diaphragm between the open and closed positions.

U.S. patent application No. 2009/078894 discloses an apparatus and methods for manual override operation of a linear actuator. An example apparatus includes a base to be mounted to an actuator. A drive member is operatively coupled to the base and selectively engagable to a stem of the actuator to enable manual operation of the actuator in a first direction and a second direction. The manual override apparatus can be retrofitted to existing control valves that are already operating in the field. For example, the control valve may be retrofitted with the manual override apparatus.

U.S. Pat. No. 6,722,528 discloses a method and apparatus for translating linear movement into rotational movement in an actuator configuration. For example, a rotary actuator assembly includes a housing having a central bore. A piston is disposed within the housing and is linearly movable along an axis of the central bore. A rolling diaphragm is disposed within the housing and coupled with the piston. A bifurcated linkage having an end flange couples with the piston and the rolling diaphragm. An articulatable coupling further connects the bifurcated linkage with a rotating linkage. A spring button, which can be cone shaped, is disposed within the housing. A compression spring is retained between the end flange of the bifurcated linkage and the spring button, for example, by a threaded rod and nut.; The assembly is arranged such that when force is applied to the rolling diaphragm the bifurcated linkage is linearly transported, which results in the pivoting of the rotating linkage about a pivot point. The pivot point can couple to a valve stem to control a valve.

A U.S. Pat. No. 3,175,473 discloses a spring and fluid pressure actuator, which includes a mechanism for locking the spring assembly parts against movement relative to the actuator housing for removing all spring force from the piston member thereof and consequently from a movable valve closing parts, and for subsequently gradually relieving the springs of their compressive force so that the actuator may be completely disassembled and reassembled without removing it from the valve.

A patent application No. EP2348238 discloses a torque limiter which can detect torque of both opening and closing of a valve and in which different torque values for opening and closing of the valve can be easily set. The torque limiter is provided with a torque arm having a connection section which is connected to a drive side gear and an intermediate gear and also having an arm section projecting from the connection section; an open side spring means and a closure side spring means which apply spring force balancing with force acting, in proportion to torque of a load in opening and closing operation of the valve, in the direction of a tangential line at the meshing point of the intermediate gear; an open side torque detection switch and a closure side torque detection switch which are, when torque of a load in opening and closing operation of the valve exceeds a predetermined value, operated by the arm section; and a torque limiter shaft passed through the open and closure side spring means. The torque limiter shaft is adapted such that spring force of each of the open and closure side spring means can be adjusted from an end of the torque limiter shaft.

A patent application No. WO1998034056 discloses a flow control device that includes a first body and a second body; a threaded engagement for clamping the bodies together in an axially aligned relationship; a diaphragm seal that is disposed axially between the first and second bodies to form a seal therebetween; each of the first and second bodies having a generally flat surface portion near its respective outer periphery; at least one of the generally flat surfaces being adjacent an outer corner thereof; the diaphragm being singularly clamped between the generally flat portions; the diaphragm having an outer peripheral portion adjacent the generally flat surfaces and that bends over and seals at the corner.

### SUMMARY OF THE INVENTION

According to one aspect of the invention there is provided a valve device for controlling passage of fluid in a flow system or part thereof, wherein the valve device comprises: (a) a diaphragm valve comprising a diaphragm and a diaphragm seat, the diaphragm valve is configured for controlling the passage of the fluid by being pressable towards and away from said seat; (b) at least one laterally movable element having part thereof engaging said diaphragm for operating the diaphragm valve; (c) an actuator for actuating the at least one laterally movable element; (d) at least one adjustment element configured for adjustment of lateral movement span of the at least one laterally movable element by adjusting a relative position thereof; and (e) at least one locking mechanism for locking the adjusted relative position of the at least one adjustment element, wherein the lateral movement span of the at least one laterally moveable element determines the maximal distance between the diaphragm and the seat, which determines the throughput of the valve device.

Optionally, the diaphragm seat is located between an inlet and/or an outlet of the flow system or part thereof and the diaphragm.

Additionally or alternatively, the at least one adjustment element comprises a bonnet having a bore for receiving the at least one laterally moveable element therein, wherein the bonnet connects to the actuator such as to create a space between the bonnet and the actuator in which part of the at least one laterally moveable element can move wherein the adjustment in the lateral movement span is done by adjusting width of the space in the actuator. The bonnet may have a screw threaded portion and the actuator may also have a corresponding screw threaded portion configured for securing to the bonnet's screw threaded portion for connecting them and for adjusting width of the space in the actuator. The locking mechanism optionally comprises a lock nut configured for locking the relative location of the bonnet in respect to the actuator by securing thereof in a releasable manner.

Additionally or alternatively to the above optional embodiments, the at least one moveable element comprises a shaft. The at least one moveable element may further comprise a cap connecting to the shaft at one end thereof and engaging the diaphragm at another end thereof.

Additionally or alternatively to the above optional embodiments, the actuator is configured for laterally moving the at least one movable element for pushing and releasing the diaphragm towards and away for the diaphragm seat. The actuator optionally comprises a body and a piston movable therein the piston connects to the adjustment element for laterally pushing and pulling thereof. The piston may be driven via pneumatic or hydraulic means, for example.

Additionally or alternatively, wherein the actuator further comprises a spring.

According to another aspect of the invention, there is provided a method for controlling passage of fluid in a flow system or part thereof, the method comprising: (a) providing a valve device having a diaphragm valve comprising a diaphragm and a diaphragm seat, a movable element, an adjustment element, an actuator for actuating movable element, and a locking mechanism; (b) adjusting maximal distance between the diaphragm and the seat by adjusting relative positioning of the adjustment element in respect to the actuator; and (c) locking the position of the adjustment element by using the locking mechanism, in a releasable manner allowing readjustment of the adjustment element relative position, wherein the relative position of the adjustment element in respect to the actuator determines lateral movement span of the at least one laterally moveable element which determines the maximal distance between the diaphragm and the seat and therefore the throughput of the valve device. The adjustment of the relative position of the adjustment element is optionally done by adjusting screwing connection thereof to the actuator and wherein the locking the adjusted relative position is carried out via a lock nut by securing thereof to the actuator or to the adjustment element.

According to yet another aspect of the invention, there is provided a valve device for controlling passage of fluid in a flow system or part thereof, the valve device comprising: (a) a diaphragm valve comprising a diaphragm and a diaphragm seat, the diaphragm valve is configured for controlling the passage of the fluid by being pressable towards and away from the seat; (b) at least one laterally movable element having part thereof engaging the diaphragm for operating the diaphragm valve; (c) an actuator for actuating the at least one laterally movable element; and (d) an adjustment and locking mechanism configured for adjusting a span of lateral movement of the at least one laterally moveable element and locking the adjusted span, wherein the lateral movement span of the at least one laterally moveable element determines the maximal distance between the diaphragm and the seat.

### BRIEF DESCRIPTION OF THE DRAWINGS

FIGS. 1A and 1B schematically illustrate a valve device in a fully open position installed at a flow system between two fluid conduits thereof, according to some embodiments of the present invention: FIG. 1A shows a side view of the valve device; and FIG. 1B shows a part of the valve device including the diaphragm valve and the shaft pushing and releasing thereof.

FIGS. 2A and 2B schematically illustrate the valve device in a semi-closed position limiting fluid passage between two fluid conduits of the flow system, according to some embodiments of the present invention: FIG. 2A shows a side view of the valve device; and FIG. 2B shows a part of the valve device including the diaphragm valve and the shaft pushing and releasing thereof.

FIG. 3 shows a cross sectional view of a valve device in a fully open position installed at a flow system between two fluid conduits thereof, according to other embodiments of the present invention.

### DETAILED DESCRIPTION OF SOME EMBODIMENTS OF THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The present invention, in some embodiments thereof, provides a valve device for controlling and adjusting passage of a fluid in a flow system or part thereof thereby controlling throughput of the valve device.

Fluid is defined hereby as liquid, gas, vapor, gel or any other material or state thereof that can flow via one or more directing elements such as tubes, pipes, conduits and the like.

Throughput of a valve is defined hereby as the volume of the fluid that passes from the input to the output of the valve.

The flow system can be any system requiring control and adjustment of flow of fluids such as an engine gas transport system, a water piping system, flow-control components for the semiconductor industry, gas and oil (energy) industry, or any other system or industry that requires valve control for fluid flow control.

According to some embodiments the valve device is configured and located such as to control fluid flow/passage between one or more outputs of at least one fluid directing means such as a tube, conduit, pipeline and the like into one or more inputs of at least one other directing means to one or more inputs of directing means. For example, the valve device may control the throughput of the fluid flow or prevent passage thereof by being located between a conduit outlet and another conduit inlet. By controlling the volume of a maximal space between the inlet and the outlet or by controlling the opening aperture of the inlet and/or the outlet of the conduits the flow throughput and passage can be controlled and adjusted according to the needs of the system. In this example, diminishing the space volume or the aperture may decrease throughput as it increases the pressure caused by the fluid flow. Complete sealing of the inlet or outlet will prevent fluid passage from the outlet into the inlet.

The valve device functions as a valve or faucet that can open and close from its adjusted most open position (in which the diaphragm is at its adjusted maximal distance from the seat) to a fully sealed position in which the diaphragm engages the seat. This is done by vertically displacing one or more elements of the adjustment set such as the shaft and movable element connected thereto, which engages the diaphragm center.

The valve device may also include a piston for pushing and releasing a diaphragm therein by vertically displacing one or more elements of thereby pumping the fluid from the outlet(s) to the inlet(s) of the flow system or part thereof.

The valve device may include a diaphragm valve comprising a diaphragm and a diaphragm seat, where the diaphragm valve is configured for controlling the passage of the fluid by being pressable towards and away from its seat; one or more laterally movable elements having part thereof engaging the diaphragm for operating it; an actuator for actuating the one or more movable elements by laterally displacing thereof; and an adjustment and locking mechanism configured for adjusting a span of lateral movement of the laterally moveable element(s) and locking the adjusted span.

The lateral movement span of the laterally moveable element(s) determines the maximal distance between the diaphragm and the seat and therefore the throughput of the valve device.

According to some embodiments of the present invention, the valve device includes at least an actuator, a diaphragm valve, one or more movable elements including a shaft and optionally another element such as a cap connected thereto engaging the diaphragm for pushing and releasing the diaphragm from operation thereof; an adjustment element comprising a bonnet in which the shaft and cap thereof moves, wherein the position of the bonnet in respect to the actuator can be adjusted to adjust lateral movement span of the shaft, and a locking mechanism for locking the adjusted relative position of the bonnet. According to some embodiments, the diaphragm valve includes a diaphragm and a diaphragm seat (also shortly referred to as “seat”), wherein the maximal distance between the diaphragm and the seat determines the throughput of the system. This maximal distance can be adjusted by adjusting the lateral span of movement of the shaft inside the bonnet.

The term “diaphragm height” refers to the distance between a center of the diaphragm and the seat thereof different diaphragm positions are defined by different distances of the diaphragm's central point from the seat. In a fully closed position the diaphragm central point either engages or is the closest to the seat it can be.

The shaft connects to the actuator at one end thereof and to the cap at its other end for engaging the diaphragm. The bonnet is a housing structure having a bore configured for enclosing at least part of the shaft and cap therein such that they can laterally move inside the bore for operating the valve (i.e. closing and opening thereof). The bonnet also serves as an adjustment element by connecting to the actuator in such a manner that allows determining the lateral span of the shaft and cap's lateral movement by its connection to the actuator. For example the part of the bonnet that connects to the actuator may have a screw thread screwable to a part of the actuator that includes a corresponding external screw thread such that the bonnet connects to the actuator by screwing thereto. The connection between the actuator and bonnet creates a space therebetween having a width “d”. The span of movement of the shaft is determined by the positioning of the bonnet in relation to the actuator which can be adjusted by the number of rotations made to screw them one to the other. Once adjusted the connection between the bonnet and the actuator can be fixated (locked) by using a lock nut or any other locking or fastening means in an easy and releasably manner making it very easy to rotate the lock nut for readjustment of the valve device.

The easy and re-doable adjustment and locking allows using the same valve device in different systems and for different purposes according to the throughput requirements of the system. The same valve device may be used in one flow system and then have its throughput capacities readjusted to be used in another flow system or another part of the same flow system.

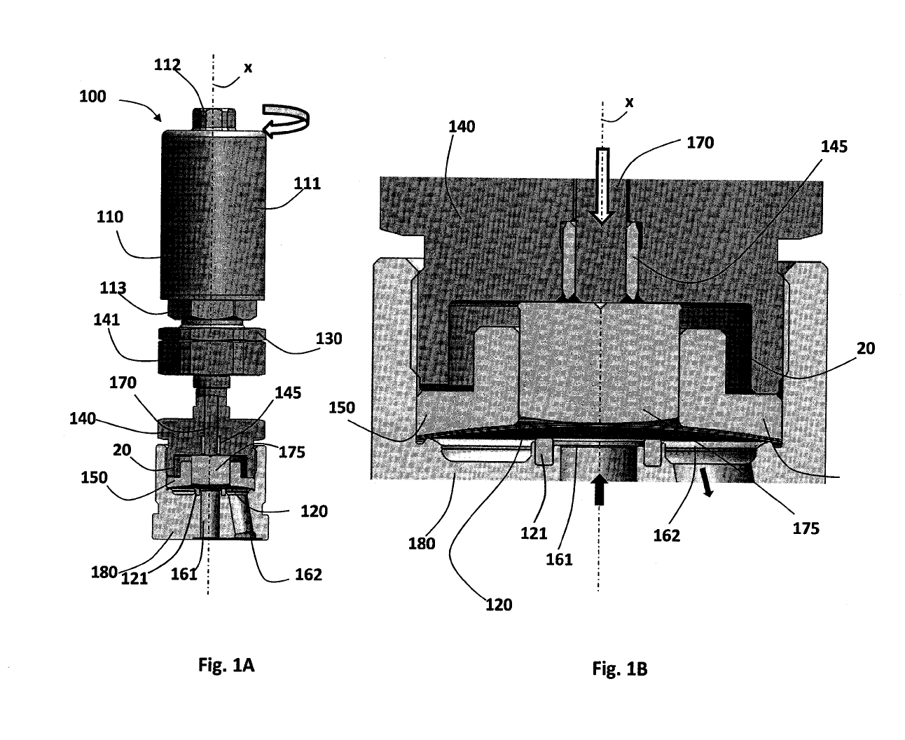

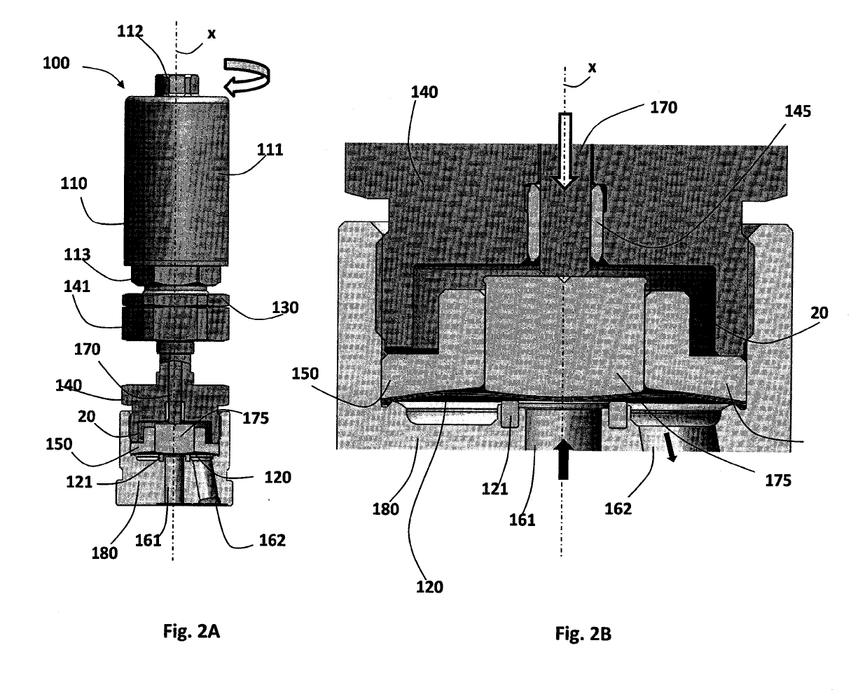

Reference is now made to FIGS. 1A, 1B, 2A and 2B, which schematically illustrate a valve device 100, according to some embodiments of the invention. The valve device 100 includes: (i) an actuator 110 (ii) moveable elements including a shaft 170 and a cap 175; (iii) an adjustment element including a bonnet 140 ; (iv) a diaphragm valve set including a diaphragm 120 and a diaphragm seat 121; (v) and a locking mechanism including a lock nut 130.

The shaft 170 is actuated by the actuator 110 by allowing lateral movement thereof along axis “x”. The bonnet 140 has an elongated bore for receiving the shaft 170 and cap 175 therein and allowing the shaft 170 to freely laterally move therein for opening and closing of the valve by pushing and releasing the diaphragm 120 from the seat 121.

The actuator 110 has a housing 111 and nuts 112 and 113. The actuator 110 connects to the bonnet 140 by fastening thereto via a bonnet nut 141 determining thereby the shaft's 170 lateral movement span. The shaft 170 is also held inside the bonnet 140 bore by a bushing 145.

As shown in in FIGS. 1A-2B the diaphragm 120 is located over an outlet of one conduit 161 of a flow system from which fluid flows outwardly and over an inlet of another conduit 162 to which the fluid exiting the first conduit 161 should be directed. Pushing the diaphragm 120 towards its seat 121 will reduce the distance therebetween and thereby reduce the space created between the diaphragm 120 and the outlet and inlet of the conduits 161 and 162. If the diaphragm 120 is fully closed i.e. fully pushed to engage the seat 121 the passage of fluid from the first conduit 161 to the second conduit 162 will be limited or sealed. If no full movement span of the shaft 170 is set, the pressure inside the space created between the diaphragm 120 and the seat 121 will increase, which may decrease throughput of the system. The opposite will occur if the diaphragm 120 will be released increasing the distance thereof from the seat 121. The conduits 161 and 162 may be located in a housing 180 of the flow system such that allows connecting thereof to the seat 121 and to the bonnet 140 of the valve device 100.

The actuator 110 may be configured for being rotated manually and/or via electronically controlled means and/or automatically in respect to the bonnet 140 and lock nut 130.

Once the position of the shaft 170 is adjusted by rotation of the actuator 110 and/or bonnet 140 in respect to the actuator 110, this position can be held by locking the lock nut 130 to the actuator 110 preventing thereby the actuator 110 or the bonnet 140 from further rotating 110.

The actuator 110 may also include pneumatic means for laterally displacing the shaft 170 for pushing and releasing the diaphragm 120 for operating the valve device 100 by having a pneumatic piston connecting or engaging the shaft 170 for laterally displacing thereof.

The adjustment of the position of the actuator 110 in respect to the bonnet 140 for adjusting the positioning of the shaft may be made through discrete predefined stages allowing the maximal distance of the diaphragm 120 to only be adjusted to several predefined distances from the seat 121, or in a continuous manner.

FIGS. 1A-1B show the valve device 100 in a fully open position in which the diaphragm 120 center is farthest from the seat 121 since the movable element 175, which moves inside a predefined space 20 between walls of a holder 150 thereof (formed between the housing 180 and the bonnet 140), has reached the bonnet 140 ceiling. In FIGS. 2A-2B the movable element 175 reached a lower semi-open point thereof in which the maximal distance from the diaphragm 120 to the seat 121 is lower than that shown in FIG. 1A.

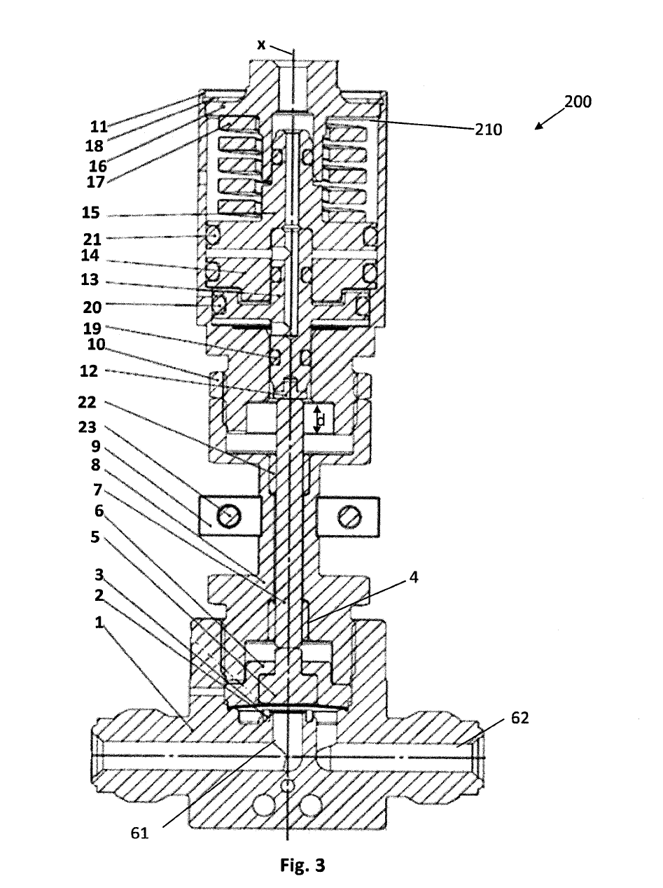

Reference is now made to FIG. 3, showing a cross sectional view of a valve device 200, according to some embodiments of the invention. The valve device 200 includes: a rotatable pneumatic actuator 210; a diaphragm valve having a diaphragm 3 and a diaphragm seat 2; moveable elements including a shaft 7 and a cap 5 connecting to an edge thereof and engaging the diaphragm 3; an adjustment element including a bonnet 8; a lock nut 10; and a holder 6 for receiving the movable element 5 therein in a movable manner. The bonnet 8 includes a bore for receiving the shaft 7 therein and connects to the actuator body 11 via a screw threaded portion thereof. Elements such as bushings 4 and 22 may be used for holding and stabilizing the shaft 7.

According to some embodiments, as shown in FIG. 3, the actuator 210 has a cover body 11 and includes therein a spring 17 and one or more pistons such as upper piston 15 and lower piston 13 for pneumatically laterally displacing the shaft 7. The pistons 13 and 15 displace a spacer 12 element that engages the upper edge of the shaft 7 for lateral displacement thereof. The actuator cover body 11 has a screw threaded portion that connects to the screw threaded portion of the bonnet 8.

Once the actuator 210 is operated the spring 17 is compressed or released depending on the desired adjustment of the diaphragm position, and the pistons 13 and 15 laterally displace the shaft 7 by pushing or pulling the spacer 12 along the “x” axis of rotation of the actuator 210.

The actuator 210 and the bonnet 8 screw threaded portion allow adjustment of the movement span of the shaft 7 by adjusting width “d” of a space created between the actuator body 11 and the bonnet 8 which determines the maximal distance between the diaphragm 3 and the seat 2 thereby determines the throughput of the fluids in the system The movable element 5 connected to the shaft 7 and engages the diaphragm 3 the seat 2 such that it laterally moves along with the shaft 7 for pushing and releasing the diaphragm 3 for operating the valve device 200. This width “d” is fixated and locked by rotating the lock nut 10 over the actuator cover 11 threaded portion for fixating the location of the bonnet 8 in respect to the actuator body 11 thereby fixating the maximal height of the diaphragm 3.

Enforcement and holding elements may be used for a better interface between the actuator body 11 and the pistons 13 and 15 such as O-rings 19-21 and plate 14 as well as for holding the spring 17 in the actuator 210 such as spring ring 18 and guide 16.

Other types of locking mechanisms can be used for locking the position of the diaphragm where the mechanism can lock the adjusted position by preventing movement of any one or more components of the valve device such as by preventing lateral and/or rotational movement of the actuator, one or more of the adjustment set element(s) such as the bonnet and the like.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments and/or by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Although the invention has been described in detail, nevertheless changes and modifications, which do not depart from the teachings of the present invention, will be evident to those skilled in the art. Such changes and modifications are deemed to come within the purview of the present invention and the appended claims.

1. A valve device for controlling passage of fluid in a flow system or part thereof, said valve device comprising:
a) a diaphragm valve comprising a diaphragm and a diaphragm seat, said diaphragm valve is configured for controlling the passage of the fluid by being pressable towards and away from said seat;
b) at least one laterally movable element having part thereof engaging said diaphragm for operating said diaphragm valve;
c) an actuator for actuating said at least one laterally movable element;
d) at least one adjustment element configured for adjustment of lateral movement span of said at least one laterally movable element by adjusting a relative position thereof; and
e) at least one locking mechanism for locking the adjusted relative position of said at least one adjustment element,
wherein the lateral movement span of said at least one laterally moveable element determines the maximal distance between said diaphragm and said seat, which determines the throughput of said valve device.

2. The valve device according to claim 1, wherein said diaphragm seat is located between an inlet and/or an outlet of said flow system or part thereof and said diaphragm.

3. The valve device according to claim 1, wherein said at least one adjustment element comprises a bonnet having a bore for receiving said at least one laterally moveable element therein, said bonnet connects to said actuator such as to create a space between said bonnet and said actuator in which part of said at least one laterally moveable element can move wherein said adjustment in the lateral movement span is done by adjusting width of said space in said actuator.

4. The valve device according to claim 3, wherein said bonnet has a screw threaded portion and said actuator has a screw threaded portion configured for securing to said bonnet's screw threaded portion for connecting them and for adjusting width of said space in the actuator.

5. The valve device according to claim 4, wherein said locking mechanism comprises a lock nut configured for locking the relative location of said bonnet in respect to said actuator by securing thereof in a releasable manner

6. The valve device according to claim 1, wherein said at least one moveable element comprises a shaft.

7. The valve device according to claim 6, wherein said at least one moveable element further comprises a cap connecting to said shaft at one end thereof and engaging said diaphragm at another end thereof.

8. The valve device according to claim 1, wherein said actuator is configured for laterally moving said at least one movable element for pushing and releasing said diaphragm towards and away for said diaphragm seat.

9. The valve device according to claim 8, wherein said actuator comprises a body and a piston movable therein said piston connects to said adjustment element for laterally pushing and pulling thereof.

10. The valve device according to claim 9, wherein said piston is driven via pneumatic or hydraulic means.

11. The valve device according to claim 9, wherein said actuator further comprises a spring.

12. A method for controlling passage of fluid in a flow system or part thereof, said method comprising:
a) providing a valve device having a diaphragm valve comprising a diaphragm and a diaphragm seat, a movable element, an adjustment element, an actuator for actuating movable element, and a locking mechanism;
b) adjusting maximal distance between said diaphragm and said seat by adjusting relative positioning of said adjustment element in respect to said actuator; and
c) locking the position of said adjustment element by using said locking mechanism, in a releasable manner allowing readjustment of said adjustment element relative position,
wherein the relative position of said adjustment element in respect to said actuator determines lateral movement span of said at least one laterally moveable element which determines the maximal distance between said diaphragm and said seat and therefore the throughput of the valve device.

13. The method according to claim 12, wherein the adjustment of the relative position of said adjustment element is done by adjusting screwing connection thereof to the actuator and wherein said locking the adjusted relative position is carried out via a lock nut by securing thereof to said actuator or to said adjustment element.

14. A valve device for controlling passage of fluid in a flow system or part thereof, said valve device comprising:
a) a diaphragm valve comprising a diaphragm and a diaphragm seat, said diaphragm valve is configured for controlling the passage of the fluid by being pressable towards and away from said seat;
b) at least one laterally movable element having part thereof engaging said diaphragm for operating said diaphragm valve;
c) an actuator for actuating said at least one laterally movable element; and
d) an adjustment and locking mechanism configured for adjusting a span of lateral movement of said at least one laterally moveable element and locking the adjusted span,
wherein the lateral movement span of said at least one laterally moveable element determines the maximal distance between said diaphragm and said seat.
